(19) United States
(12) Patent Application Publication
(10) Pub. No.: US 2006/0233598 A1
(43) Pub. Date: Oct. 19, 2006

(54) Interconnection unit for structural elements

(75) Inventors: Silvio Corrias, Torino (IT); Giorgio Boero, Asti (IT); Angela Falagario, Torino (IT)

Correspondence Address: SUGHRUE MION, PLLC, 2100 PENNSYLVANIA AVENUE, N.W., SUITE 800, WASHINGTON, DC, 20037, US

(73) Assignee: CRF SOCIETA CONSORTILE PER AZIONI

(21) Appl. No.: 11/454,041

(22) Filed: Jun. 16, 2006

Related U.S. Application Data
(63) Continuation of application No. 10/332,369, filed on Aug. 25, 2003, now abandoned.

(30) Foreign Application Priority Data
Jul. 7, 2000 (IT) TO2000A000684

(51) Int. Cl. F16B 7/04

(52) U.S. Cl. 403/217

(57) ABSTRACT

The interconnection unit (1) includes a metal junction element (2) with at least one channel-shape arm (2a), with an end portion of at least one connector element (3) positioned therein; and a reinforcing grid structure (6) injection moulded from plastics material inside the metal junction element (2) once the said at least one connector element (3) has been placed in position, and secured both to the metal junction element (2) and to the said at least one connector element (3).

This is a National Stage Entry of Application No. PCT/EP01/07659, filed Jul. 4, 2001; the disclosure of which is incorporated herein by reference.

### BACKGROUND OF THE INVENTION

The present invention relates to a connector for structural elements, for use in assembling structures with a high performance/weight ratio, such as motor vehicle bodies.

### SUMMARY OF THE INVENTION

One object of the invention is to provide an interconnection unit which is both simple and economical to manufacture and which offers high structural strength.

This and other objects are achieved according to the invention by providing an interconnection unit the main characteristics of which are defined in the appended claim 1.

Other characteristics and advantages of the invention will become apparent from the detailed description which follows, provided purely by way of non-limitative example, with reference to the appended drawings, in which

### BRIEF DESCRIPTION OF THE DRAWINGS

FIGS. 1 and 2 are perspective views of an interconnection unit of the invention;

FIG. 3 is a perspective view of an interconnection unit of the invention during one stage of its manufacture;

FIG. 4 is a partial perspective view of a detail of FIG. 3;

FIG. 5 is a cross section taken on the line V-V of FIG. 1, and

FIG. 6 is a section taken on the line VI-VI of FIG. 1.

### DETAILED DESCRIPTION OF THE INVENTION

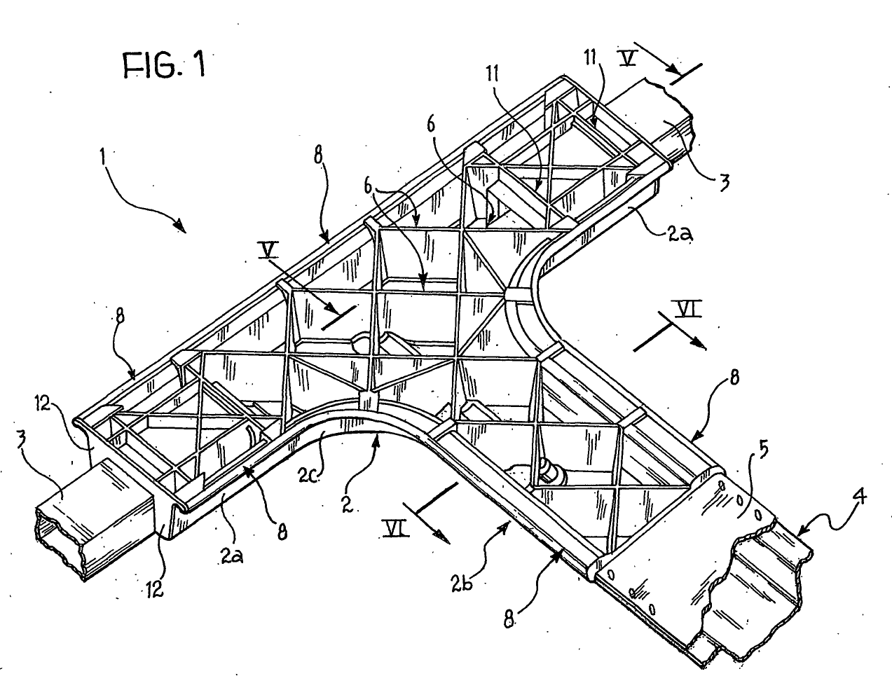

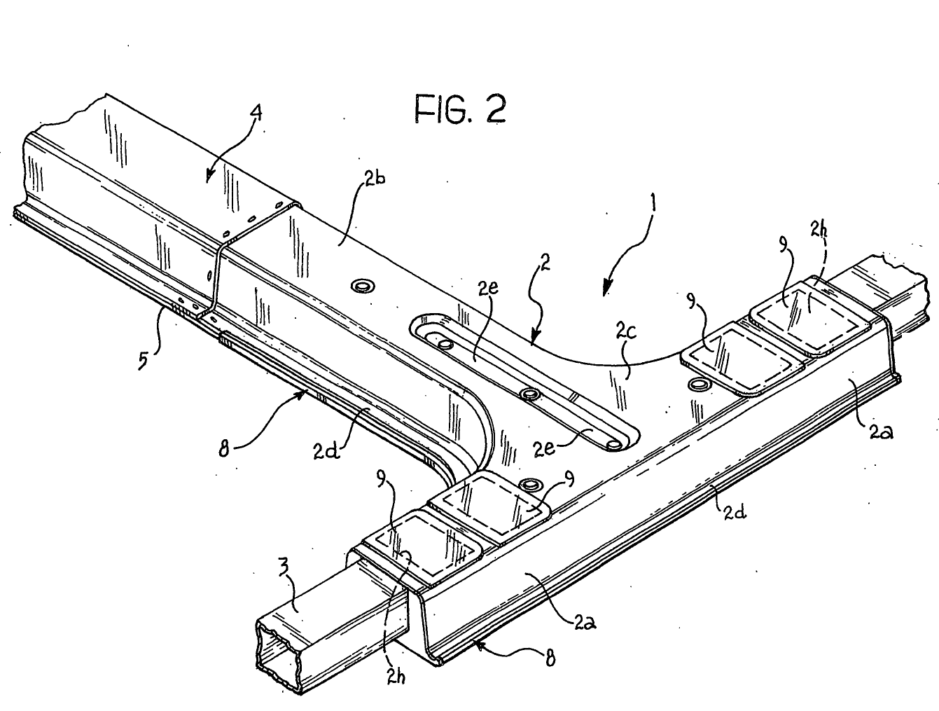

In FIGS. 1 and 2, an interconnection unit of the invention is generally indicated 1.

In the embodiment shown by way of example, the interconnection unit 1 includes an essentially T-shaped metal junction element 2, with two essentially aligned arms 2a and one arm 2b which extends from an intermediate portion 2c (see FIG. 2 in particular).

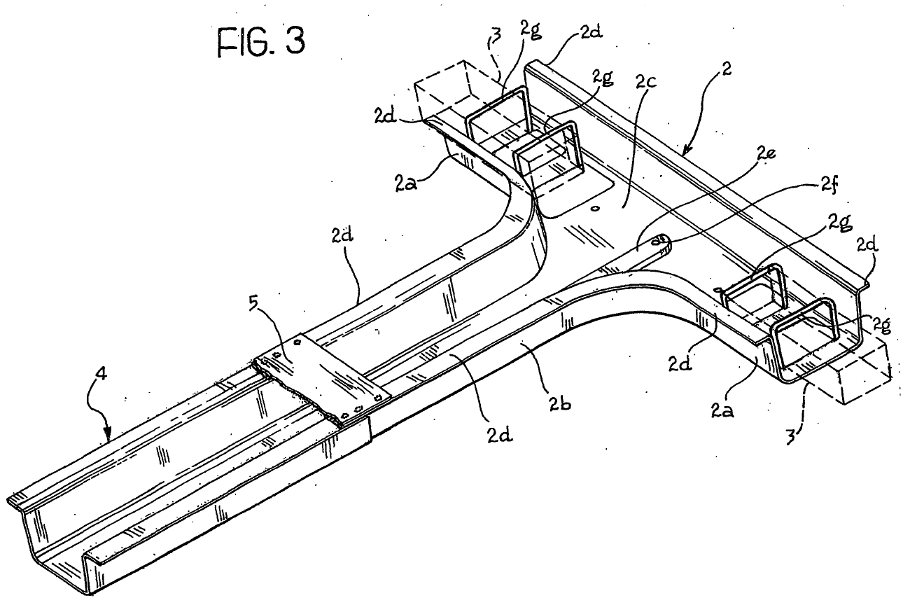

The arms 2a and arm 2b of the metal junction element 2 are essentially channel-shaped. The top edges of the sides of these arms of the junction element 2 form respective outwardly facing flanges, indicated 2d in FIGS. 3, 4 and 6. In the intermediate portion 2c, an indentation 2e is formed in the bottom surface of the junction element 2, preferably so as to project inwardly of the channel-shaped section, as can be seen from FIGS. 2, 3 and 6.

The indentation 2e is elongate and extends at least in part into the arm 2b of the junction element 2. For reasons which will be explained later, a plurality of openings 2f are conveniently formed in the top surface of the indentation 2e (see FIGS. 3, 5 and 6).

The junction element 2 is preferably made of steel, or aluminium or an alloy thereof, or magnesium or an alloy thereof. The junction element 2 may be shaped by any known method, for example by bending, rolling or hydro-forming sheet metal, or by drawing or casting in a mould.

The junction element 2 can conveniently be made in one piece, being either of substantially uniform or varying thickness. In this second case, the junction element 2 can be made from multi-layered sheet metal and/or from compound materials, bonded together by the so-called tailored blank method. Alternatively, the junction element 2 can be assembled from several components, possibly constituted by different materials and of varying thicknesses, each component being manufactured by a moulding method known per se and then assembled with the others using connectors manufactured by known methods.

With reference once again to FIGS. 1 and 2, the end portions of two connector elements 3, intended to be connected (in a way which is not shown) to other structural elements such as girders, tie rods, rafters or the like in order to form complex structures, are positioned and secured to the arms 2a of the junction element 2.

In the embodiment illustrated by way of example, these connector elements form a closed section. However such connector elements could have an open section.

Like the junction element 2, the connector elements 3 are conveniently made of metal: steel, aluminium or an alloy thereof, or magnesium or an alloy thereof, for example.

Depending on either opportunity or requirements, the connector elements 3 can be made of a different material to that of the junction element 2.

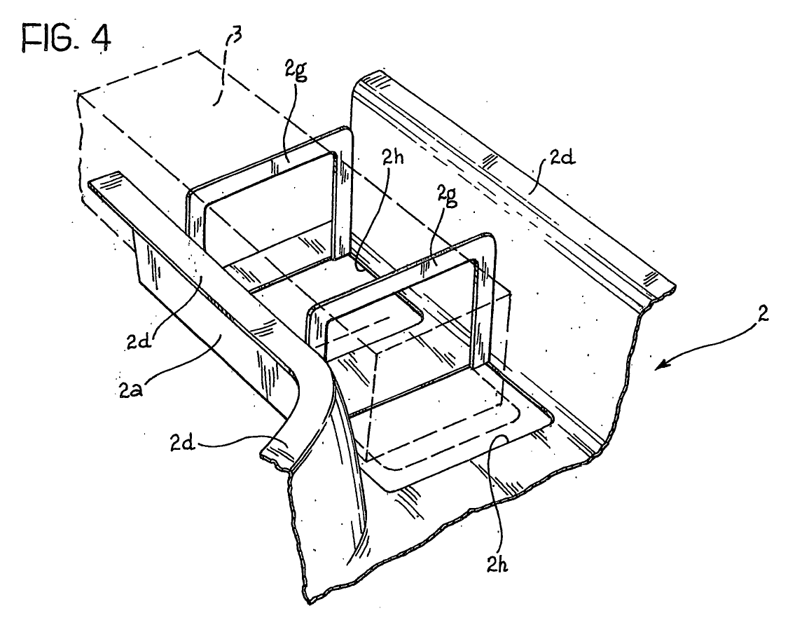

With reference in particular to FIGS. 3 and 4, a pair of essentially C-shape brackets 2g extend from the bottom surface of the arms 2a of the junction element 2. For convenience, these brackets are made in one piece with the junction element 2 by means of operations involving cutting and folding upwards.

The brackets 2g of the arm 2a of the junction element 2 are of a size which enables the end portions of the connector elements 3 to be inserted therein, as shown in FIGS. 3 and 4 in particular.

In the embodiment illustrated by way of example, a structural element 4, made of the same material as the junction element 2, is secured to the arm 2b of the junction element 2. The structural element 4 is also channel-shaped in cross section.

The arm 2b of the junction element 2 may be thicker so that, thus reinforced, it ensures that stress is transferred gradually to and from the structural element 4. Alternatively, as shown in FIGS. 2 and 3, the end portions of the arm 2b of the junction element 2 and of the structural element 4 respectively are superimposed and fixed mechanically, by spot welding for example. A plate, such as that indicated 5 in FIGS. 1, 2 and 3 could also be fixed to the structural element 4, by welding for example.

During assembly, the connector elements 3 positioned in the brackets 2g of the junction element 2 can be made more secure by welding or adhesive.

The interconnection unit 1 also includes a reinforcing grid structure, indicated 6 in FIG. 1. This structure is made of a plastics material, a thermoplastics material for preference, which is injection-moulded into the metal junction element 2 after the connector elements 3 have been positioned and the additional structural element 4 has been attached.

The reinforcing grid structure 6 is securely fixed both to the metal junction element 2 and to the connector elements 3. In the embodiment shown, it includes a plurality of more or less orthogonally intersecting walls, fixed to the sides and to the bottom of the arms 2a, 2b of the junction element 2.

The cross section of the base of the ribs or walls of the grid structure 6 can be enlarged to form a square, a rectangle, a triangle, a trapezoid, a semicircle or the like, of suitable dimensions so as to form a preferential flow path for the plastics material during moulding.

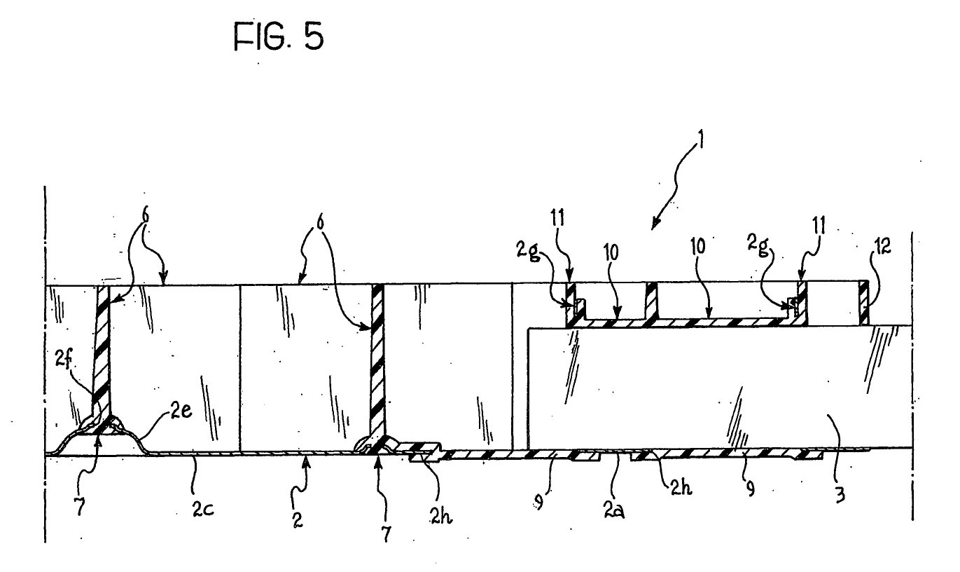

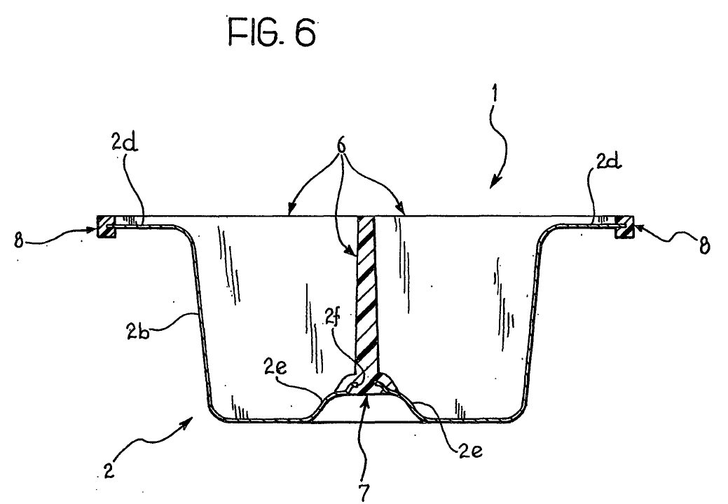

Many methods can be used to secure the grid structure 6 to the junction element 2. In the example illustrated, (see FIGS. 5 and 6 in particular) it is secured to the base wall of the junction element 2 at the site of holes, such as those 2f formed through the indentation 2e. During moulding an enlarged formation 7 is formed either side of the hole, at the base of one of the walls or partitions forming the grid structure, or at an intersection thereof.

The joins or fixings between the grid structure 6 and the junction element 2 can be of various shapes: a circle for example, or an ellipse or a symmetrical or asymmetrical cruciform shape.

At the sides of the arms 2a, 2b of the junction element 2, the grid structure 6 is fixed, for example, as shown in FIG. 6. In this arrangement, a bead 8 is formed during moulding along the edges of the flange 2d of these sides (see FIG. 2).

During the moulding of the reinforcing grid structure 6, the connector elements 3 are partially surrounded and secured by formations of moulded plastics material which insinuate themselves into the apertures 2h (see FIG. 4) in the bottom wall of the arms 2a of the junction element 2 by the formation of the brackets 2g. These formations of plastics material are indicated 9 in FIGS. 2 and 5.

The end portions of the connector elements 3 of the junction element 2 are fixed at the top by a further flat formation of plastics material, such as that indicated 10 in FIG. 5. This formation is formed in one piece with transverse ribs 11 which can advantageously envelop the brackets 2g. It is particularly advantageous to envelop the brackets when the connector elements 3 are made of a different material from that of the junction element 2, since by preventing contact by these different materials it is possible to prevent galvanization from causing them to corrode.

Referring to FIG. 1, end closure walls 12 can be formed in one piece with the grid structure 6 across the end portions of the arms 2a of the junction element 2, so as to sealably surround the connector elements 3.

The grid structure can be more securely fixed to the connector elements 3 by arrangements similar to those described with regard to securing the said reticular structure to the junction element 2.

It is convenient, though not necessary, for the grid structure 6 to have weakened portions which can serve as collapse initiators, for example in the event of a crash of the structure of which the connector forms part. These weakened portions can consist of localized areas where the walls or partitions forming the grid structure are thinner in cross section, or in portions with an exaggerated curvature, operable to serve as flexing initiators.

Naturally, the principle of the invention remaining unchanged, embodiments and manufacturing details may vary widely from those described and illustrated purely by way of non-limitative example, without departing thereby from the scope of the invention, as claimed in the appended Claims.

So, for example, the metal junction element 2 could be pre-cut and then positioned in a mould operable to give the pre-cut element the desired shape, with the plastics material for forming the grid structure, and any other structures described above, then being injection moulded.

1-24. (canceled)

25. A method of forming an interconnection unit, comprising the following steps:
forming a metal junction element with at least one arm having a channel therein;
securing the metal junction element to at least one connector element; and
injection molding a plastic material into the channel so as to form a reinforcing grid structure, said injection molding occurring after the at least one connector element has been position and secured to the junction element.

26. The method of claim 25, wherein said forming step includes the step of forming the metal junction element in one piece.

27. The method of claim 25, wherein said forming step includes the step of forming said metal junction element in composite layers using sheet metal bonded together.

28. The method of claim 25, further comprising a step of providing at least one bracket which extends from the surface of at least one said arm of the junction element for enclosing the end portion of said at least connector element.

29. The method of claim 28, wherein said at least one bracket extends from the base of one arm of the junction element.

30. The method of claim 25, wherein the at least one connector element is made of metal.

31. The method of claim 25, wherein the at least one connector element is made of a different metal from that of the junction element, with separating formations made of said plastic material interposed there between.

32. The method of claim 28, further comprising the step of covering said at least one bracket element with the plastic material covering said grid structure.

33. The method of claim 25, further comprising the step of providing one of holes and grooves in the junction element and in said at least one connector element to secure the reinforcing grid structure.

34. The method of claim 25, wherein said forming step includes the step of forming the junction element with an additional channel-shaped arm and securing an additional junction element thereto.

35. The method of claim 25, wherein the grid structure has weakened portions in predetermined areas operable to act as collapse initiators.

36. The method of claim 35, wherein at least one of the weakened portions is locally curved by more than a predetermined value.

37. The method of claim 25, wherein the grid structure includes a plurality of ribs or walls with an enlarged cross-section at the base.

38. The method of claim 25, further comprising a step of forming end closure walls in one-piece with the grid structure, which extend across the end portion of the arms of the junction elements and sealably surround connector elements.

39. The method of claim 25, further comprising a step of forming at least one indentation in the base of the junction element so as to project inwardly of the channel shape section of the junction element.

40. The method of claim 25, further comprising the step of forming at least on indentation in a base of the junction element so as to project inwardly of the channel.
